(19) United States
(12) Patent Application Publication
(10) Pub. No.: US 2026/0252857 A1
(43) Pub. Date: Aug. 27, 2026

(54) Uncertainty-Aware Token Generation Using Extanglement Metrics in Transformer Models

(71) Applicants: Thomas Michael Taylor, Kelowna (CA); Jack McKenzie Taylor, North Vancouver (CA); Bao Q Tran, Saratoga, CA (US)

(72) Inventors: Thomas Michael Taylor, Kelowna (CA); Jack McKenzie Taylor, North Vancouver (CA); Bao Q Tran, Saratoga, CA (US)

(21) Appl. No.: 19/064,453

(22) Filed: Feb. 26, 2025

(51) Int. Cl. G06N 3/0475; G06F 40/284; G06N 3/0455; G06N 3/048

(52) U.S. Cl. CPC G06N 3/0475; G06F 40/284; G06N 3/0455; G06N 3/048

(57) ABSTRACT

The present invention discloses “Extanglement,” a novel uncertainty modeling mechanism and corresponding decoding algorithm for Artificial Intelligence Transformer models, specifically designed to enhance reasoning and significantly reduce hallucinations in Large Language Models (LLMs) (See FIG. 2.1~Extanglement Transformer Decoding). The core insight of Extanglement is that LLMs inherently model uncertainty in their token predictions, and this invention proposes leveraging this intrinsic uncertainty as a guiding signal for improved decoding, rather than suppressing it as in conventional methods. The method involves: measuring “extanglement” (a quantitative uncertainty metric, including but not limited to entropy, probability gap, Gini Impurity, and Top-K Probability Mass, and potentially wavelet-based measures) in the output probability distribution generated by the Transformer's softmax layer; comparing this metric to a dynamically adjustable Extanglement threshold; and guiding the decoding process based on this comparison. When extanglement is high (indicating high uncertainty), the model may “pause” and further refine its prediction through uncertainty handling operations. When extanglement is low (indicating acceptable certainty), a token is selected and output. This “extanglement-aware” decoding method empowers LLMs to generate more reliable, more coherent, and less hallucination-prone text by directly respecting and strategically utilizing their intrinsic uncertainty modeling capabilities. This represents a significant advancement in the field of AI reasoning and trustworthiness, offering a paradigm shift in decoding strategies for generative AI.

### BACKGROUND OF THE INVENTION

The present invention relates generally to the field of artificial intelligence and, more specifically, to natural language processing and generation by Large Language Models (LLMs).

Transformer models have rapidly become a cornerstone in fields such as natural language processing and computer vision owing to their ability to capture intricate dependencies in data through self-attention mechanisms. Despite their widespread adoption, a recurring challenge has been the effective handling of uncertainty during the decoding phase, where the confidence in generated outputs can vary significantly. This variability has spurred research into advanced decoding strategies that incorporate uncertainty estimation to improve model reliability and robustness. Additionally, emerging approaches that draw inspiration from concepts of entanglement—originally rooted in quantum theory—aim to model interdependencies more effectively during decoding, thereby offering promising avenues to mitigate ambiguity and enhance the overall performance of these architectures. The present invention relates generally to the field of artificial intelligence and, more specifically, to natural language processing and generation by Large Language Models (LLMs). More particularly, the present invention relates to methods, systems, and computer-readable media for improving the reasoning capabilities of large language models (LLMs) based on Transformer architectures, specifically addressing and mitigating the issue of hallucinations in generated content by leveraging intrinsic model uncertainty

### SUMMARY OF THE INVENTION

In one aspect, a method comprises generating a probability distribution over a vocabulary for predicting the next token using a transformer model's softmax layer. The method further entails calculating an extanglement metric that measures the uncertainty associated with the probability distribution and comparing this metric to a preset extanglement threshold. In one aspect, if the extanglement metric exceeds the threshold, the method performs an uncertainty handling operation selected from a group consisting of pausing token commitment, performing further internal processing, dynamically adjusting decoding parameters, and combinations thereof. In another aspect, if the extanglement metric is below the threshold, the method selects a token from the probability distribution and outputs it. The process is then repeated for subsequent token predictions to generate a sequence of tokens. Large Language Models (LLMs) based on the Transformer architecture have achieved state-of-the-art performance in various natural language processing and generation tasks. These models, trained on vast amounts of text data, exhibit remarkable abilities in understanding, generating, and manipulating human language.

In another aspect a method for uncertainty-aware decoding in an artificial intelligence transformer model is provided wherein the model first generates a probability distribution over a vocabulary to predict the next token. The method further calculates an extanglement metric for the probability distribution and compares this metric to a preset extanglement threshold. If the extanglement metric exceeds the threshold, the method performs an uncertainty handling operation, whereas if the metric is below the threshold, a token is selected and output. The process is repeated for predicting subsequent tokens, and in certain embodiments the extanglement metric is defined as the entropy of the probability distribution.

In light of the limitations of conventional approaches and the persistent problem of hallucinations in Large Language Models (LLMs), the present invention introduces “extanglement,” a novel and effective mechanism for uncertainty modeling in Artificial Intelligence Transformers. extanglement is specifically designed to enhance the reasoning capabilities of LLMs and drastically reduce the generation of hallucinations in their outputs.

The core and fundamental concept of extanglement is to explicitly recognize, measure, and strategically leverage the inherent uncertainty that is naturally expressed by LLMs during the process of token prediction. Instead of attempting to suppress or ignore this intrinsic uncertainty, as is the focus of many existing methods, extanglement embraces and utilizes it as a valuable signal to guide the decoding and generation process.

The invention directly challenges the underlying assumption of conventional methods, which posit that minimizing output entropy and forcing certainty is the primary path to reducing hallucinations. extanglement posits that these certainty-focused methods are counterproductive and may mask or amplify the very problem they aim to solve.

At its core, extanglement recognizes and builds upon the inherent capability of LLMs, specifically through their softmax layer, to model uncertainty. For each token prediction, the softmax layer naturally produces a probability distribution over the entire vocabulary. This probability distribution is not merely a set of scores; it inherently reflects the model's confidence (or lack thereof) in its prediction for the next token. In the context of extanglement, a high degree of “extanglement” (conceptually analogous to high entropy) signifies greater uncertainty within the model's prediction. Conversely, a low degree of “extanglement” (analogous to low entropy) indicates a higher level of certainty and confidence in the prediction.

To operationalize the concept of extanglement, the present invention proposes specific methods to measure and effectively utilize “extanglement” during the decoding process. These methods include, but are not limited to:

Real-time Monitoring of extanglement Continuously monitoring and quantifying the “extanglement” (i.e., uncertainty) of the output probability distribution generated by the softmax layer for each token prediction during the decoding process. This measurement provides a dynamic and step-by-step assessment of the model's confidence in its ongoing generation.

Establishing a Dynamic “extanglement threshold”: Defining and adaptively adjusting an “extanglement threshold.” This threshold represents a pre-determined or dynamically learned level of acceptable model certainty for token prediction. The threshold serves as a critical decision point in the extanglement-aware decoding process, differentiating between states of acceptable certainty and unacceptable uncertainty.

Uncertainty-Driven Modification of Decoding Process Strategically modifying the decoding process based on the real-time comparison of the measured extanglement and the established extanglement threshold. Specifically:

High Extanglement Response (Uncertainty Handling): When the measured “extanglement” exceeds the pre-defined or dynamically adjusted threshold, indicating a state of high uncertainty in the model's prediction, the decoding process is intentionally modified to allow the model to “pause,” “think,” or further refine its prediction before definitively committing to a token. This “pause” or refinement phase may involve techniques such as iterative refinement, re-sampling, dynamic parameter adjustment, or other uncertainty-handling mechanisms as described in further detail below.

Low Extanglement Action (Token Commitment): Conversely, when the measured “extanglement” falls below the threshold, indicating a state of sufficient certainty and confidence in the prediction, the model proceeds to select and output a token. This token selection can be performed using standard decoding strategies such as greedy decoding (selecting the token with the highest probability) or sampling-based approaches, as appropriate for the specific application.

By intelligently employing “extanglement-aware” decoding, the present invention directly aims to empower LLMs to engage in more robust and reliable reasoning processes. By respecting and responding to their own intrinsic confidence levels, LLMs can make more informed predictions that are better grounded in their internal representations and input context. This approach is expected to ultimately and drastically reduce the occurrence of hallucinations and inaccuracies in the generated content, leading to outputs that are more trustworthy, factually consistent, and logically sound.

The extanglement mechanism represents a significant paradigm shift in decoding strategies for LLMs and generative AI. It moves away from the conventional approach of forcing artificial certainty, which has proven to be limited and potentially counterproductive. Instead, extanglement pioneers a novel approach by embracing and strategically leveraging the model's inherent uncertainty as a powerful asset for improving overall AI performance, reasoning fidelity, and trustworthiness.

In a further aspect, extanglement is used to provide an uncertainty modeling mechanism for Artificial Intelligence Transformers that enhances reasoning and reduces hallucinations in Large Language Models (LLMs). Extanglement recognizes that LLMs inherently model uncertainty in their token predictions and proposes leveraging this uncertainty, rather than suppressing it as in conventional methods. The method involves measuring “extanglement” (related to entropy) in the output probability distribution of the Transformer, establishing an extanglement threshold, and guiding the decoding process based on this threshold. When extanglement is high (high uncertainty), the model may “pause” and further refine its prediction. When extanglement is low (acceptable certainty), a token is output. This “extanglement-aware” decoding method enables LLMs to generate more reliable, less hallucination-prone text by respecting and utilizing their intrinsic uncertainty modeling capabilities, representing a significant advancement in AI reasoning and trustworthiness.

Advantages of the above methods may include one or more of the following:
Enhanced Robustness and Reliability: By incorporating an extanglement metric to assess uncertainty during token generation, the method dynamically adjusts the decoding process, thereby reducing the likelihood of erratic or ambiguous outputs. This results in improved model reliability, particularly in applications where accurate and contextually relevant generation is critical.
Improved Handling of Ambiguity: The uncertainty-aware decoding approach enables the system to identify and effectively manage cases of high uncertainty. When the extanglement metric exceeds a preset threshold, uncertainty handling operations such as pausing token commitment or adjusting decoding parameters help mitigate potential errors, leading to a more robust performance across diverse and challenging input scenarios.
Adaptive Decoding Process: The ability to dynamically choose between token selection and uncertainty handling operations based on real-time analysis of the probability distribution allows the transformer model to optimally balance speed and accuracy. This adaptive decoding process ensures that computational resources and processing time are allocated efficiently, enhancing overall system performance.
Increased Confidence in Generated Outputs: By incorporating uncertainty estimation through metrics such as entropy, the model can actively monitor and address low-confidence situations. This leads to the generation of outputs with greater consistency and fewer spurious or irrelevant tokens, thus increasing the overall confidence in the model's predictions.
Potential for Higher-Quality Natural Language Processing (NLP) Applications: In applications where nuance and precision are essential, such as conversational agents and machine translation, the improved uncertainty handling can lead to outputs that better capture contextual subtleties. This results in communications that are both coherent and contextually appropriate.
Flexibility Across Multiple Domains: Although described in the context of language modeling, the underlying approach may be applied to other transformer-based applications, such as computer vision, where uncertainty estimation and robust decoding are beneficial. This cross-domain applicability enhances one implementation's overall utility and impact.
Scalability and Integration Ease: The proposed method can be integrated into existing transformer architectures with minimal changes to the core model. As a result, developers can incorporate uncertainty-aware decoding into current systems without extensive retraining or architectural redesign, ensuring a scalable solution adaptable to evolving needs.

These advantages together provide a comprehensive improvement over conventional transformer decoding mechanisms, ensuring that the model's predictions are both contextually aware and robustly managed in the face of uncertainty.

### BRIEF DESCRIPTION OF DRAWINGS

FIG. 1A shows a Traditional Transformer Decoding (for Comparison) while FIG. 1B shows an example of Extanglement Transformer Decoding.

FIG. 2A shows an illustration of one embodiment with extanglement.

FIG. 2B shows flowchart depicting steps for uncertainty-aware token generation using extanglement metrics in transformer models.

### DETAILED DESCRIPTION OF THE INVENTION

The invention, termed “extanglement,” is a novel decoding mechanism designed to operate within the context of Artificial Intelligence Transformer models, particularly during the crucial decoding or generation phase of Large Language Models (LLMs). It is applicable to any Transformer-based LLM architecture that utilizes a softmax output layer to produce a probability distribution over a vocabulary for token prediction.

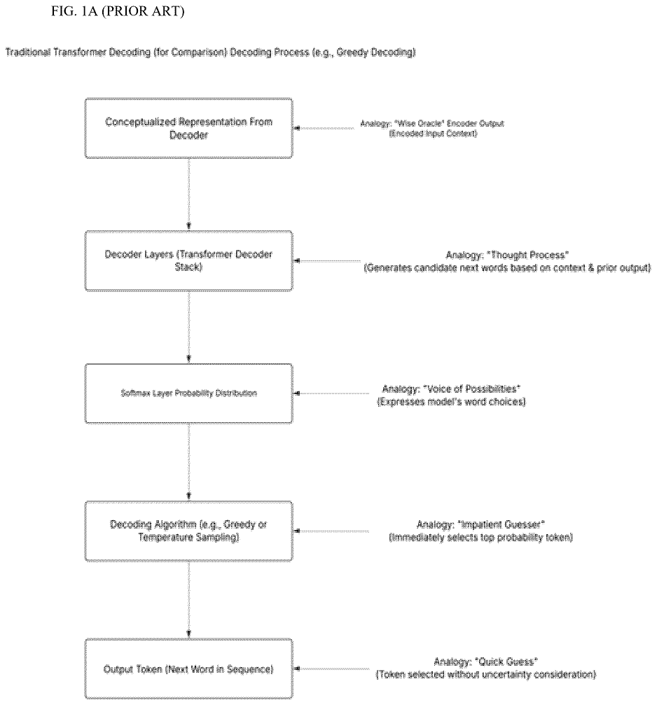

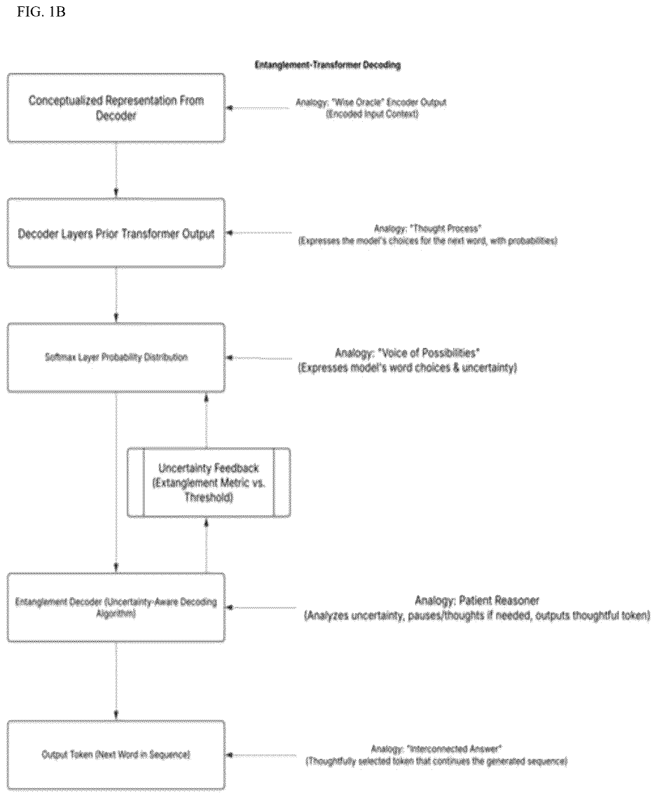

FIG. 1A shows a Traditional Transformer Decoding (for Comparison): The traditional transformer uses Greedy Decoding, Temperature Sampling, among others. As shown therein, the conventional system is absent of uncertainty measurement and feedback in the decoding process, for comparative purposes.

FIG. 1B shows an example of Extanglement Transformer Decoding. The diagram represents the key stages: Contextualized Representation input, Decoder Layers, Softmax Layer (Probability Distribution output), Entanglement Decoder block performing Uncertainty Metric Calculation and Thresholding, Uncertainty Handling Operations (conditional path), and finally Output Token.) At a conceptual level, “extanglement” is intrinsically related to the fundamental concept of information entropy from information theory. It serves as a quantifiable measure of the inherent uncertainty present within the model's token prediction process. However, the key innovation of extanglement lies in its departure from conventional entropy-minimization approaches. Unlike existing methods that aim to minimize entropy as a direct route to hallucination reduction, “extanglement” uniquely proposes to strategically utilize this uncertainty measurement, not as something to be suppressed, but as a dynamic and informative guiding mechanism for achieving improved reasoning and effective hallucination mitigation.

The principle of extanglement is based on the observation that the probability distribution generated by the softmax layer of an LLM naturally encodes the model's uncertainty about its next-token prediction. A distribution that is spread thinly across many possible tokens signifies high uncertainty, while a distribution sharply peaked around a single token indicates high confidence. extanglement leverages this inherent signal.

The concept of “extanglement” can be more deeply understood and operationalized by considering its manifestations at various key stages of a Transformer's operation. While Output Probability Distribution extanglement is central to the decoding algorithm, understanding extanglement in other parts of the Transformer provides valuable context and potentially points to further refinements or extensions of the invention. These stages are:
4.4.1. Input sequence extanglement:
4.4.1.1. Concept: Input sequence extanglement refers to the inherent randomness or unpredictability present within the input sequence itself. This is a characteristic of the input data, not directly a part of the model's internal workings, but it can influence model behavior. For example, an input sequence consisting of highly structured, grammatically correct, and semantically predictable text would exhibit lower input sequence extanglement. Conversely, a noisy input sequence containing grammatical errors, semantic anomalies, or random data would demonstrate higher input sequence extanglement.
4.4.1.2. Relevance: The level of input sequence extanglement in the input can indirectly influence the expected behavior and performance of the Transformer model. When presented with lower extanglement input (more predictable input), we might expect the Transformer to learn and exhibit more deterministic mappings and generate more constrained outputs. In contrast, when processing higher extanglement input (more noisy or unpredictable input), the Transformer might need to develop greater robustness to noise and uncertainty inherent in the input, potentially leading to more diverse or exploratory outputs.
4.4.2. Attention distribution extanglement:
4.4.2.1. Concept: Attention distribution extanglement pertains to the degree of uncertainty that is reflected in the attention weights generated by the self-attention mechanism within the Transformer layers. In Transformer models, the self-attention mechanism calculates attention weights, which form a probability distribution over the input sequence for each output position. These attention weights quantify how much each part of the input sequence is “attended to” when generating a particular output token. The distribution of these attention weights can be analyzed to determine its extanglement level.
4.4.2.2. High Attention extanglement: A high Attention extanglement is characterized by a more diffuse or broadly distributed attention pattern. This occurs when the model attends to many different parts of the input sequence relatively equally, with no single part receiving dominant attention. This can be interpreted as representing a less focused or more distributed information selection process within the model. In information-theoretic terms, high Attention extanglement suggests the model is considering a wider contextual scope and not strongly prioritizing specific input elements.
4.4.2.3. Low Attention extanglement: Conversely, low Attention extanglement is characterized by a more focused or peaked attention distribution. This occurs when the model strongly attends to only a small number of specific parts of the input sequence, while largely ignoring the majority of other input elements. This attention pattern represents a highly selective information retrieval process, where the model emphasizes only the most salient and relevant parts of the input for generating the current output. Information-theoretically, this corresponds to a more deterministic and focused extraction of information from the input context.

The system uses “extanglement,” a novel mechanism for uncertainty modeling in Artificial Intelligence Transformers designed to enhance reasoning and drastically reduce hallucinations in Large Language Models (LLMs). The extanglement concept is used to recognize and leverage the inherent uncertainty expressed by LLMs during token prediction, rather than suppressing or ignoring it. In extanglement, the system acknowledge and utilizes the model's intrinsic uncertainty, particularly as reflected in the probability distribution output by the softmax layer, we can guide the decoding process
4.4.3. Output probability distribution extanglement:
4.4.3.1. Concept: Output Probability distribution extanglement, which is central to this invention, is defined as the uncertainty directly associated with the probability distribution over the vocabulary that is generated by the Transformer's output (softmax) layer for each token prediction in generative tasks such as text generation or machine translation. By measuring the extanglement of this probability distribution, we gain direct insight into the model's level of confidence or uncertainty in its choice of the next token to generate.
4.4.3.2. High output extanglement: A high Output extanglement signifies a state of greater uncertainty regarding the model's next word prediction. In this case, the probability mass of the distribution is spread more evenly across a relatively large number of possible words in the vocabulary. This indicates that the model is experiencing ambiguity or exploring a diverse set of potential continuations for the generated sequence. High Output extanglement might be observed in situations requiring creativity, open-ended generation, or when multiple semantically plausible continuations exist.
4.4.3.3. Low Output extanglement: Conversely, a low Output extanglement indicates a state of high model confidence in its prediction for the next token. Here, the probability distribution is heavily concentrated on one or a very small number of words in the vocabulary. This pattern suggests that the model has reached a strong conviction in its chosen token and is predicting it with high certainty. Low Output extanglement might lead to more conservative, deterministic, and factually grounded generation, potentially reducing creativity but increasing reliability.
4.4.4. Representation extanglement (hidden state extanglement):
4.4.4.1. Concept: Representation extanglement, also referred to as hidden state extanglement, pertains to the uncertainty that is embedded within the hidden state vectors of the Transformer layers. These hidden states encompass various internal representations learned by the model, including word embeddings, outputs of self-attention mechanisms, and outputs of Feed-Forward Network (FFN) layers at different depths within the network. In principle, it is possible to measure the extanglement of these hidden representations at different layers of the Transformer. Analyzing this representation extanglement can provide insights into the “information content” or “randomness” captured in the learned feature representations at various stages of processing.
4.4.4.2. Relevance: The relevance and interpretation of representation extanglement are more complex and nuanced than output probability distribution extanglement. Higher representation extanglement might, in some cases, be indicative of richer and more diverse feature representations, potentially allowing the model to capture a wider range of semantic information and subtle nuances in the input data. However, higher representation extanglement could also, in other contexts, signify the presence of noise or less structured and less informative representations. Principles from Information Bottleneck theory and related concepts in representation learning suggest that there may be a need to carefully balance representation extanglement. The goal might be to achieve a level of representation extanglement that facilitates the learning of compressed yet sufficiently information-rich representations that are optimal for the task at hand.
4.5. Method of utilizing extanglement for improved decoding:
4.5.1. The core of the present invention resides in the specific method of utilizing the concept of output probability distribution extanglement as a dynamic and adaptive guiding mechanism for the decoding process in Transformer-based LLMs. The extanglement-aware decoding algorithm fundamentally alters the token generation process to be sensitive to the model's own uncertainty.
4.5.2. A preferred embodiment of an “extanglement Ddecoder” would incorporate the following algorithmic steps to achieve uncertainty-aware decoding:
4.5.2.1. Uncertainty metric calculation: For each token prediction step in the decoding process, the first crucial step is to calculate a quantitative metric that accurately reflects and quantifies the output probability distribution extanglement. As discussed above, suitable metrics derived from information theory can be employed. Exemplary and non-limiting metrics include Entropy-based extanglement and probability gap extanglement, described previously. In addition to these, other metrics that capture different aspects of distributional uncertainty can also be utilized, such as Gini impurity extanglement and Top-K Probability Mass extanglement, detailed below. Furthermore, more advanced signal processing techniques, such as wavelet analysis, could also be adapted to derive sophisticated extanglement metrics, although the simpler metrics provide a computationally efficient and conceptually clear starting point.

Advantages and benefits of extanglement: *(As previously described in extanglement 0.4)*
to generate more reliable and less hallucination-prone text. Extanglement recognizes that LLMs, through their softmax layer, inherently model uncertainty by producing a probability distribution over the vocabulary for each prediction. This distribution reflects the model's confidence (or lack thereof) in its next-token prediction. High “extanglement” (analogous to high entropy) signifies greater uncertainty, while low “extanglement” (analogous to low entropy) indicates higher certainty.

The method includes monitoring the “extanglement” (uncertainty) of the output probability distribution for each token prediction. The method uses an “extanglement threshold” representing an acceptable level of model certainty. The method modifies the decoding process such that when the “extanglement” exceeds the threshold (high uncertainty), the model is allowed to “pause,” “think,” or further refine its prediction before committing to a token. Conversely, when the “extanglement” is below the threshold (sufficient certainty), the model proceeds to select and output a token. By employing “extanglement-aware” decoding, the method aims to enable LLMs to engage in more robust reasoning, make more informed predictions based on their intrinsic confidence levels, and ultimately, drastically reduce the occurrence of hallucinations in generated content. This approach represents a paradigm shift from forcing artificial certainty to embracing and leveraging the model's inherent uncertainty for improved AI performance

A probability distribution over a vocabulary is generated for predicting a subsequent token by utilizing a softmax layer within a transformer model. In one embodiment, the transformer model computes likelihood values for each token in the vocabulary, resulting in a probability distribution that reflects the model's confidence in each candidate token. Reference label S100 identifies the step during which this probability distribution is produced, thereby establishing the foundation for subsequent token prediction processes. The computed distribution enables the model to weigh token probabilities appropriately, forming the basis for further operations such as the calculation of an uncertainty metric and the adjustment of decoding parameters in response to measured uncertainty.
4.4. The concept of “extanglement” can be understood in relation to various stages of a Transformer's operation:
   4.4.1. Input Sequence extanglement:
      4.4.1.1. Concept: Input Sequence extanglement refers to the inherent randomness or unpredictability of the input sequence itself. Highly structured, predictable input text exhibits lower Input Sequence extanglement, while noisy or random data demonstrates higher input sequence extanglement.
      4.4.1.2. Relevance: The level of input sequence extanglement can influence the expected behavior of the Transformer. Lower extanglement input may lead to more deterministic mappings learned by the model, while higher extanglement input might necessitate greater model robustness to noise and uncertainty in the input.
   4.4.2. Attention distribution extanglement:
      4.4.2.1. Concept: Attention distribution extanglement pertains to the uncertainty reflected in the attention weights produced by the self-attention mechanism within Transformer layers. These weights, forming a probability distribution over the input sequence for each output position, can be analyzed for their extanglement level.

High attention extanglement: A high Attention extanglement indicates a more diffuse or broad attention distribution, where the model attends to many parts of the input sequence relatively equally. This can be interpreted as a less focused information selection, potentially considering a wider contextual scope.

Low Attention extanglement: Conversely, low Attention extanglement suggests a more focused or peaked attention distribution, where the model strongly attends to only a few specific parts of the input sequence, largely ignoring others. This represents selective information retrieval, emphasizing specific relevant input elements.

Output probability distribution extanglement is detailed next. Output probability distribution extanglement is the uncertainty associated with the probability distribution over the vocabulary generated by the Transformer's output layer for each token prediction in generative tasks. Measuring the extanglement of this distribution provides insight into the model's confidence in its next-token choice. High output extanglement signifies greater uncertainty regarding the next word prediction. The probabilities are spread more evenly across multiple possible words, suggesting model ambiguity or exploration of diverse options. This might correlate with creativity or situations where multiple continuations are plausible.
4.4.3.3. Low output extanglement: Low output extanglement indicates high model confidence in its prediction. The probability distribution is heavily concentrated on one or a few words, suggesting strong conviction in the chosen token and potentially leading to more conservative or deterministic generation. Representation extanglement, or hidden state extanglement, refers to the uncertainty embedded within the hidden state vectors of the Transformer layers, including embeddings, attention outputs, and Feed-Forward Network (FFN) outputs. Analyzing the extanglement of these hidden representations at different layers can reveal the “information content” or “randomness” captured in the learned features. Interpreting representation extanglement is more complex. Higher representation extanglement might indicate richer, more diverse feature representations, but could also signify noise or less structured representations. Principles from Information bottleneck theory suggest a potential need to balance representation extanglement, aiming for compressed yet information-rich representations.

A preferred embodiment of an “extanglement decoder” would incorporate the following steps: For each token prediction, calculate a metric that quantifies the output probability distribution extanglement. Possible metrics include: Entropy of the probability distribution with a direct measure of uncertainty. Higher entropy indicates higher extanglement and greater uncertainty. Probability Gap is determined, where the difference in probability between the most likely token and the second most likely token. A smaller gap suggests higher extanglement and greater uncertainty. Other information-theoretic measures reflecting distribution spread or peakedness could also be employed.

Establish a threshold value for the chosen extanglement metric. This threshold represents a level of acceptable model certainty. The threshold value may be determined empirically or adaptively adjusted based on task requirements or model performance.

The decoding algorithm with extanglement thresholding is now detailed. For each token to be generated:
Generate the probability distribution over the vocabulary from the Transformer's softmax layer using a decoding temperature that allows for sufficient exploration (temperature values greater than zero, and potentially higher than those used in greedy decoding alternatives).
Calculate the chosen extanglement metric for the generated probability distribution.
Compare extanglement to threshold:
   If extanglement is above the threshold (high uncertainty): Indicate that the model's uncertainty is unacceptably high. In this state, the decoding process may:
      Introduce a “pause” mechanism, delaying token commitment and allowing further internal processing. This “pause” could be implemented through techniques such as iterative refinement, re-sampling, or continuation of internal Transformer layer computations without outputting a token.
      Dynamically adjust decoding parameters (e.g., temperature, sampling strategy) to encourage the model to explore more options and potentially reduce uncertainty.
         Extanglement is below the threshold (acceptable uncertainty): Indicate that the model has reached a sufficient level of certainty. Proceed with token selection and output:
         Select the token with the highest probability (akin to greedy selection, but now guided by the extanglement threshold).
         Alternatively, sample from the top tokens of the distribution, while still ensuring the extanglement threshold is met.
         Output the selected token and append it to the generated sequence.
         Repeat for subsequent token generation until a termination condition is met (e.g., sequence length limit, end-of-sequence token generation).

Advantages and benefits of extanglement includes the following. By decoding based on intrinsic model uncertainty, “extanglement” is expected to significantly reduce hallucinations compared to methods that force certainty through low temperature or greedy decoding. Allowing the model to “pause” and “think” when uncertain, as guided by “extanglement,” to promote deeper and more deliberate reasoning processes within the LLM, leading to more coherent and accurate outputs. By generating content with lower hallucination rates, LLMs employing “extanglement” decoding become more trustworthy and reliable for various applications, increasing their potential for wider adoption. The “extanglement” leverages the inherent uncertainty modeling capacity of Transformers, turning a previously ignored or suppressed feature into a valuable asset for improved performance. The extanglement” represents a shift from forcing artificial certainty to embracing and utilizing model uncertainty, potentially revolutionizing decoding strategies for LLMs and generative AI.

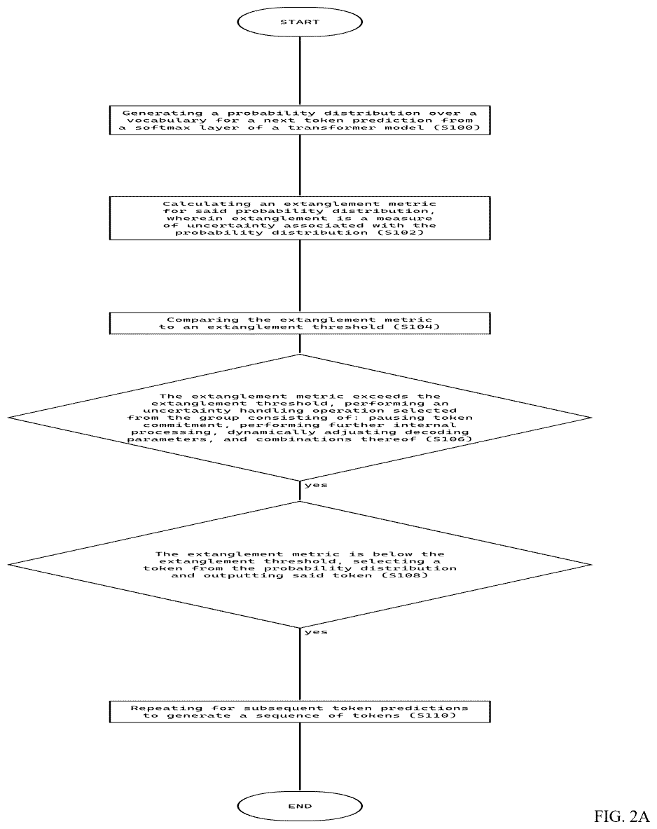

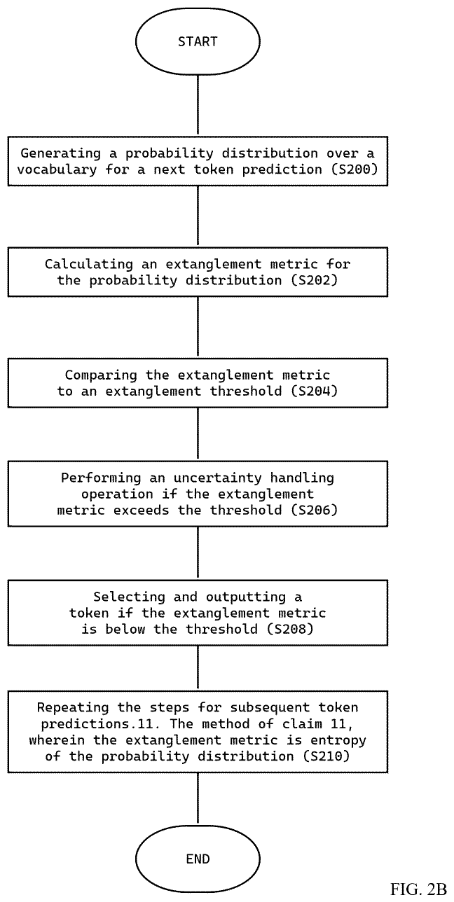

One implementation shown in FIG. 2A discloses a method for uncertainty-aware decoding in a transformer model that dynamically adjusts its token prediction process based on uncertainty analysis. Initially, a probability distribution is generated over a vocabulary to predict the next token using the transformer's softmax output. In one embodiment, the method calculates an extanglement metric for the probability distribution, where extanglement acts as a measure of the uncertainty associated with the probability distribution, as described in step S102. The extanglement metric is then compared to a preset threshold. When the extanglement metric exceeds the threshold, the transformer performs an uncertainty handling operation, which can include pausing token commitment, performing further internal processing, dynamically adjusting decoding parameters, or combinations thereof. Should the extanglement metric fall below the threshold, a token is selected from the generated probability distribution and outputted. This process is repeated for subsequent token predictions, ensuring that the generated sequence of tokens is robust and contextually appropriate, especially in scenarios where maintaining output quality is essential.

The comparing step, indicated by reference label S104, is instrumental in enabling the dynamic adjustment of decoding operations based on the computed measure of uncertainty. By assessing the extanglement metric against the threshold, the method ensures that the transformer model can handle conditions of notable uncertainty through appropriate handling operations. This approach improves the robustness and reliability of the model, especially in scenarios where the precise and contextually appropriate generation of tokens is essential.

In embodiments where the extanglement metric is determined to be below the extanglement threshold, a specific operation is executed in which a token is selected according to the probability distribution and then output as the predicted token. This step, designated as S108, provides a token commitment when the uncertainty is relatively minimal, thereby permitting the decoding process to proceed with the sequential prediction of tokens in line with the confidence levels derived from the calculated metric.

The process is repeated for subsequent token predictions to form a complete sequence of tokens. Specifically, the aspect described as “repeating for subsequent token predictions to generate a sequence of tokens (S110)” is implemented by iteratively executing the steps of generating the next token's probability distribution, calculating the corresponding extanglement metric, comparing the metric to the preset threshold, and performing either the uncertainty handling operation or the token selection based on the outcome of this comparison. This iterative mechanism adapts to varying uncertainty levels in real time, thereby enhancing the robustness and reliability of the transformer model's output generation.

FIG. 1B illustrates a flowchart depicting steps for uncertainty-aware token generation using extanglement metrics in transformer models.

Step S202 involves calculating an extanglement metric for the probability distribution generated by the model. This metric provides a measure of uncertainty associated with the distribution. By evaluating this uncertainty, the method can assess the model's confidence in predicting the next token, which is essential for subsequent decision-making processes regarding token generation.

The reference label “S206” describes an uncertainty handling operation activated when the extanglement metric exceeds a predetermined threshold. This operation manages the uncertainty inherent in token predictions generated by the transformer model. When the extanglement metric, which quantifies uncertainty, surpasses the set threshold, this step triggers measures to address the uncertainty. These measures include pausing token commitment, engaging in additional internal processing, dynamically adjusting decoding parameters, or combining these strategies. This procedure enhances the robustness and reliability of token generation by mitigating potential erratic or ambiguous outputs.

In one embodiment, when the computed extanglement metric associated with the probability distribution exceeds a predetermined threshold, the system introduces a pause mechanism to delay token commitment as part of the uncertainty handling operation. When notable uncertainty is detected, the pause mechanism is activated to temporarily suspend the immediate selection and output of a token from the probability distribution, allowing additional internal processing or recalibration of decoding parameters before final token commitment. This pause mechanism involves a predetermined waiting period or an adaptive delay based on ongoing analysis of the extanglement metric and associated probability distribution. Introducing this mechanism ensures that token prediction is not based solely on an uncertainty measure; instead, further processing is carried out to refine the prediction based on updated model parameters or reconsideration of the available probability distribution. By delaying token commitment, the system permits re-assessment of the confidence levels of its prediction, which in turn results in a more reliable selection of tokens in subsequent steps. This approach is implemented by temporarily halting the progression of token sequence generation until the computed extanglement metric falls below the threshold, at which point the system resumes token selection and outputs the token based on the adjusted probability distribution. The pause mechanism enhances the reliability of the generated output by reducing the likelihood of committing to tokens when uncertainty is pronounced, thus facilitating more accurate and contextually appropriate sequence generation.

In embodiments where the uncertainty handling operation involves performing additional internal processing within the Transformer model, an internal processing routine is triggered when the extanglement metric exceeds the extanglement threshold, and this occurs prior to token selection. In these embodiments, the Transformer model performs extra computations within its internal layers by re-processing intermediate representations generated during the initial forward pass. This additional internal processing includes, for example, re-evaluating the hidden state activations, adjusting the attention weights across multiple layers, and executing supplementary non-linear transformations of the internal feature representations. By carrying out these extra computations, the Transformer model works to reduce uncertainty associated with the token probability distribution, thereby refining the prediction outcome. The internal processing operation evaluates and recalibrates the contextual information stored within the network so that subsequent token predictions derive from an updated internal state that better reflects the current input context. This approach enables the model to mitigate the effect of extanglement—which indicates greater uncertainty—by dynamically enhancing the internal data representations before the final selection of a token. As a result, the model is able to generate sequences that are more coherent and contextually appropriate, even when faced with initially ambiguous or uncertain predictions.

This method reduces the incidence of hallucinations in the generated token sequence compared to techniques that enforce certainty through a reduced temperature setting or greedy decoding. By incorporating an evaluation of uncertainty via the extanglement metric, the method avoids overcommitting to tokens predicted with unwarranted confidence-a condition that can lead to erroneous or fabricated tokens. Instead, by dynamically managing cases of considerable uncertainty through pausing, additional processing, or adjusting decoding parameters, the risk of integrating inaccurate or hallucinated content is mitigated. This strategy contrasts with decoding approaches that artificially force strong certainty, such as those employing a reduced temperature setting or greedy selection, both of which can result in premature token commitment and an increased likelihood of hallucinated content. The integration of an uncertainty-aware framework into the token prediction process produces a more robust generation method that upholds fidelity to the input context while diminishing the occurrence of spurious or unsupported tokens.

The multidimensional nature of the extanglement metric enables the incorporation of various components of uncertainty. For example, the metric includes measures related to both the dispersion of the probability distribution and the degree of confidence in the prediction. This multifaceted approach allows the transformer to robustly engage in scenarios where binary decisions must be made, such as committing to a token prediction or deferring commitment pending further internal analysis-even in circumstances where the decision could potentially be incorrect. Integrating a confidence signal into the extanglement thus enhances the decision-making process by providing a nuanced view of the risk associated with each prediction, facilitating a more refined and dynamic handling of uncertainty in token generation.

Utilizing the entropy of the probability distribution as the entanglement metric provides a quantifiable measure of uncertainty, which empowers the method to adapt its response dynamically throughout the decoding process based on the uncertainty of each prediction. This approach is designed for implementation in real-time or batch-processing environments using systems configured to run deep learning models, and it is embodied in software instructions stored on a non-transitory computer-readable medium or integrated within dedicated hardware.

In one embodiment, after generating a probability distribution for the next token prediction, the extanglement metric is computed as the difference between the probability assigned to the token with the highest likelihood and that assigned to the token with the second highest likelihood. In this embodiment, the transformer model produces a probability distribution over the vocabulary, and the extanglement metric is determined by identifying the token with the highest probability along with the token that follows, then calculating the difference between their probabilities. A relatively substantial probability gap indicates that the model exhibits an elevated level of confidence in its token prediction, whereas a narrow gap conveys an increased degree of uncertainty. Accordingly, if the computed probability gap falls below a predetermined extanglement threshold, the system interprets the situation as uncertain and is configured to delay token commitment, engage in additional internal processing, dynamically adjust decoding parameters, or perform a combination of these actions to address the uncertainty. Conversely, if the probability gap exceeds the threshold-signifying sufficient confidence-a token is selected from the probability distribution and output as the next token in the generated sequence. This process is repeated iteratively for each subsequent token prediction. Such embodiments provide an alternative method for quantifying uncertainty in transformer model outputs, in which the probability gap, rather than traditional metrics such as entropy, is utilized to guide subsequent processing steps in generating coherent and contextually appropriate token sequences.

In one embodiment, when the extanglement metric falls beneath the extanglement threshold, the method selects a token from the probability distribution by sampling from its top tokens. In this embodiment, the set of top tokens is defined through a predetermined cutoff—for instance, a fixed number k of tokens with maximal probabilities or a probability threshold that ensures only tokens whose probabilities exceed a certain level are considered. The process of sampling from the top tokens introduces a controlled degree of randomness into the token selection process while still favoring tokens with greater likelihoods, thereby balancing determinism and variability in the generated sequence. For example, rather than deterministically selecting the token with the maximal probability, the system identifies a subset of tokens representing the top candidates from the probability distribution and then chooses one token at random from this subset using a stochastic sampling algorithm. This approach helps mitigate issues such as repetition or over-commitment to a single token prediction that can occur when always opting for the token with the maximum probability. In some embodiments, the number of tokens considered in the top subset is dynamically adjusted based on additional factors such as the computed extanglement metric or specific application requirements. Furthermore, sampling from the top tokens can be executed using various techniques known in the art, including temperature-controlled softmax sampling, beam search refinement, or other probabilistic sampling methods that balance exploration and exploitation during the token generation process. This embodiment improves the robustness of the token prediction mechanism, enabling the system to accommodate fluctuations in uncertainty by selecting tokens from a refined subset of tokens with maximal probabilities when the overall uncertainty—as measured by the extanglement metric—is determined to be sufficiently minimal.

By employing a decoding temperature greater than zero, one implementation provides a mechanism to adjust the behavior of token generation in transformer-based models. This adjustment contributes to enhanced control over output diversity and uncertainty management, ensuring that the predicted token sequence accurately reflects the underlying intent and mitigates issues associated with overly deterministic token commitment.

In embodiments incorporating adaptive control based on model performance, the extanglement threshold is adjusted according to performance metrics observed during model operation. In these embodiments, model performance is evaluated by assessing factors such as successful token predictions, error rates, or overall uncertainty trends over time. Based on this evaluation, the extanglement threshold is increased to reduce premature uncertainty handling operations when the model demonstrates optimal performance or decreased to initiate uncertainty handling more readily when the model performance indicates elevated levels of uncertainty. This adaptive threshold adjustment occurs dynamically during the token prediction process, ensuring that the uncertainty handling mechanism remains optimized for the model's current operating conditions.

In additional embodiments, the process involves terminating the token generation process upon reaching a predetermined sequence length limit, thereby ensuring that the generated output does not exceed a preset length. The foregoing description serves to illustrate example embodiments of one implementation, and various modifications and changes can be incorporated without departing from the scope of the appended claims.

In certain embodiments, the transformer model is configured to generate an end-of-sequence token, with the appearance of this token signifying that the token generation process is terminated. For example, during the iterative generation of tokens, after a token is selected and output as described by the uncertainty-aware mechanism, the output token undergoes analysis to determine whether it corresponds to a predetermined end-of-sequence token. If the token is identified as the end-of-sequence token, the token generation process immediately ceases, thereby terminating further token generation. In this manner, the transformer language model not only employs entanglement-based uncertainty management when selecting tokens but also ensures that processing stops when the complete sequence is delineated, as signaled by the appearance of the end-of-sequence token. This feature operates either as a subsequent step following the uncertainty handling operation or as an integrated component of the repetition cycle, whereby each predicted token is evaluated both for uncertainty conditions and for termination criteria based on token identity.

### EXAMPLES

Extanglement can be generated using metrics from information theory. Two suitable metrics are:

### 1. Entropy-Based Extanglement (EH)

Formula: Given a probability distribution P=(p1, p2, . . . , pV) over the vocabulary of size V, the Entropy-based Extanglement (EH) is defined as the Shannon Entropy:

EH(P)=−>Σi=1V pi log 2 (pi)·
Interpretation:
   Higher EH indicates higher Extanglement and greater uncertainty. A higher entropy value means the probability distribution is more spread out, suggesting the model is less confident in its prediction (more “entangled” among possibilities).
   Lower EH indicates lower Extanglement and higher certainty. A lower entropy value means the probability distribution is more peaked, suggesting the model is more confident in its prediction.
   The base of the logarithm (here, base 2) can be adjusted (e.g., natural logarithm ‘In’ can also be used).

### 2. Probability Gap Extanglement (EG)

Formula: Let p(1) be the highest probability in P and p(2) be the second highest probability in P. The Probability Gap Extanglement (EG) is defined as the probability difference between the top two choices:

EG(P)=p(1)−p(2)
Interpretation:
   Lower EG indicates higher Extanglement and greater uncertainty. A smaller probability gap means the model is less certain about its top choice, as the second choice is almost as likely.
   Higher EG indicates lower Extanglement and higher certainty. A larger probability gap means the model is more confident in its top choice, as it is significantly more probable than the next best option.

### Mathematical Representation of Extanglement-Aware Decoding Algorithm

Here's a more formalized representation of the Extanglement-Aware Decoding algorithm, incorporating the mathematical metrics: Algorithm: Extanglement-Aware Decoding

### Input:

Transformer Model
Initial Context C0
Extanglement Threshold TE
Extanglement Metric EE{EH,EG} (choose either Entropy or Probability Gap) Output: Generated Token Sequence S=[t1, t2, . . . , tL]

### Initialization:

Generated sequence S=[ ]
Current Context C=C0
   Decoding Loop (for Each Step k=1, 2, . . . , Lmax, where Lmax is Maximum Sequence Length):
1. Probability Distribution Generation: Generate the probability distribution P(k) over the vocabulary V using the Transformer model, conditioned on the current context C: P(k)=Transformer (C)
2. Extanglement Metric Calculation: Calculate the Extanglement metric E(k) for the probability distribution P(k):
   If using Entropy-based Extanglement: E(k)=EH(P(k))=−Σi=1V pi(k) log 2 (pi(k))
   If using Probability Gap Extanglement: E(k)=EG(P(k))=p(1)(k)−p(2) (k) (where p(1)(k) and p(2)(k) are the top two probabilities in P(k))
3. Threshold Comparison and Uncertainty Handling:
   For Entropy-based Extanglement (EH): If E(k)>TE://High Uncertainty (Extanglement above threshold) Perform Uncertainty Handling Operation (e.g., pause, refine, adjust parameters). In a simplified form, we might just re-sample or iterate the decoding step. For now, let's assume a ‘pause’ which is a placeholder for more complex operations. Else://Acceptable Uncertainty (Extanglement below or at threshold) Select the next token tk from P(k) (e.g., by argmax or sampling). Append tk to S. Update context C=C⊕tk (concatenate tk to context).
   For Probability Gap Extanglement (EG): If E(k)<TE://High Uncertainty (Probability Gap below threshold) Perform Uncertainty Handling Operation (e.g., pause, refine, adjust parameters). Else://Acceptable Uncertainty (Probability Gap above or at threshold) Select the next token tk from P(k) (e.g., by argmax or sampling). Append tk to S. Update context C=C⊕tk.
4. Termination Check: Check if a termination condition is met (e.g., sequence length Lmax reached, End-of-Sequence token generated). If yes, terminate the loop.
   Output: The generated token sequence S=[t1, t2, . . . , tL].

“““Python Jupyter Notebook example to demonstrate the calculation of Extanglement metrics and a simplified Extanglement-aware decoding logic.”””

import numpy as np from
scipy.stats import entropy

```
  # --- Function to Calculate Entropy-based Extanglement (EH) --- def
entropy_extanglement(prob_distribution):
    “““Calculates Entropy-based Extanglement (Shannon Entropy).”””
    # Ensure it's a probability distribution (normalize if needed, though softmax should
output probabilities) prob_distribution = np.array(prob_distribution) prob_distribution
= prob_distribution / np.sum(prob_distribution)
    # Calculate entropy using scipy.stats.entropy (natural log by default, use base=2 for bits if
needed) ent_value = entropy(prob_distribution, base=2) # Base 2 for bits return
ent_value
# --- Function to Calculate Probability Gap Extanglement (EG) ---
def probability_gap_extanglement(prob_distribution):
    “““Calculates Probability Gap Extanglement (difference between top 2 probabilities).”””
prob_distribution = np.array(prob_distribution)
    top_probs_indices = np.argsort(prob_distribution)[::−1] # Indices of probabilities in
descending order top_prob = prob_distribution[top_probs_indices[0]] second_top_prob =
prob_distribution[top_probs_indices[1]] prob_gap = top_prob − second_top_prob return
prob_gap
  # --- Example Probability Distributions (Simulating Softmax Output) ---
# Example 1: High Uncertainty − Spread out probabilities
prob_dist_high_uncertainty = [0.1, 0.15, 0.2, 0.18, 0.12, 0.05, 0.08, 0.07, 0.03, 0.02]
  # Example 2: Low Uncertainty − Peaked probability distribution prob_dist_low_uncertainty =
[0.8, 0.05, 0.04, 0.03, 0.02, 0.01, 0.01, 0.01, 0.01, 0.02]
  # Example 3: Moderate Uncertainty prob_dist_moderate_uncertainty = [0.3, 0.25, 0.15, 0.1,
0.08, 0.04, 0.03, 0.02, 0.01, 0.02]
# --- Calculate Extanglement Metrics for Examples ---
# Entropy-based Extanglement (EH) eh_high =
entropy_extanglement(prob_dist_high_uncertainty) eh_low =
entropy_extanglement(prob_dist_low_uncertainty) eh_moderate =
entropy_extanglement(prob_dist_moderate_uncertainty)
print(“Entropy-based Extanglement (EH):”) print(f“
High Uncertainty: {eh_high:.4f}”) print(f“ Low
Uncertainty: {eh_low:.4f}”) print(f“ Moderate
Uncertainty: {eh_moderate:.4f}\n”)
# Probability Gap Extanglement (EG) eg_high =
probability_gap_extanglement(prob_dist_high_uncertainty) eg_low =
probability_gap_extanglement(prob_dist_low_uncertainty) eg_moderate =
probability_gap_extanglement(prob_dist_moderate_uncertainty)
  print(“Probability Gap Extanglement (EG):”) print(f“ High Uncertainty: {eg_high:.4f}”)
print(f“ Low Uncertainty: {eg_low:.4f}”) print(f“ Moderate Uncertainty:
{eg_moderate:.4f}\n”)
  # --- Simplified Extanglement-Aware Decoding Logic (Illustrative) ---
  def simplified_extanglement_decoding(prob_distribution, entanglement_threshold,
use_entropy_metric=True):
    “““
    Simplified decoding based on Extanglement. Demonstrates thresholding logic.
    Not a full Transformer implementation.
    ”””
    if use_entropy_metric:
      extanglement_value = entropy_extanglement(prob_distribution)
      is_uncertain = entanglement_value > entanglement_threshold # Higher entropy = higher
uncertainty else: # Use Probability Gap extanglement_value =
probability_gap_extanglement(prob_distribution)
      is_uncertain = entanglement_value < entanglement_threshold # Lower gap = higher
uncertainty
    if is_uncertain:
      print(“ Uncertainty HIGH (Extanglement: {:.4f}). Performing Uncertainty Handling
(Simulated Pause).”.format(extanglement_value))
      # In a real system, here you'd implement pause, refinement, etc.
# For simplicity, we'll just return a placeholder “uncertainty_token”
return “<UNCERTAIN_TOKEN>”
    else:
      predicted_token_index = np.argmax(prob_distribution) # Greedy selection for simplicity
      predicted_token = f“Token_{predicted_token_index+1}” # Assume vocabulary is Token_1,
Token_2...
      print(“ Uncertainty LOW (Extanglement: {:.4f}). Predicting Token:
{ }”.format(extanglement_value, predicted_token))
return predicted_token
# --- Example Decoding with Extanglement Threshold ---
print(“\n--- Decoding with Entropy-based Extanglement Threshold ---”) entropy_threshold = 2.0
# Example threshold (needs tuning)
decoded_token_1_entropy = simplified_extanglement_decoding(prob_dist_high_uncertainty,
entropy_threshold, use_entropy_metric=True)
decoded_token_2_entropy = simplified_extanglement_decoding(prob_dist_low_uncertainty,
entropy_threshold, use_entropy_metric=True)
decoded_token_3_entropy =
simplified_extanglement_decoding(prob_dist_moderate_uncertainty, entropy_threshold,
use_entropy_metric=True)
  print(“\n--- Decoding with Probability Gap Extanglement Threshold ---”)
prob_gap_threshold = 0.6 # Example threshold (needs tuning)
  decoded_token_1_gap = simplified_extanglement_decoding(prob_dist_high_uncertainty,
prob_gap_threshold, use_entropy_metric=False) # use_entropy_metric=False for gap
decoded_token_2_gap = simplified_extanglement_decoding(prob_dist_low_uncertainty,
prob_gap_threshold, use_entropy_metric=False)
decoded_token_3_gap = simplified_extanglement_decoding(prob_dist_moderate_uncertainty,
prob_gap_threshold, use_entropy_metric=False)
```

### Explanation of the Python Notebook and Subsequent Python:

1. Import Libraries: Imports numpy for numerical operations and scipy.stats.entropy for Shannon Entropy calculation.
2. entropy_extanglement(prob_distribution) function: Calculates
   Entropy-based Extanglement using the formula. It normalizes the input to ensure it's a valid probability distribution and then uses seipy.stats.entropy.
3. probability_gap_extanglement(prob_distribution) function: Calculates
   Probability Gap Extanglement. It finds the top two probabilities and returns their difference.
4. Example Probability Distributions: Defines three example probability distributions to represent scenarios with high, low, and moderate uncertainty.
5. Calculate and Print Extanglement Metrics: Calls the functions to calculate EH and EG for each example distribution and prints the results, showing how the metrics reflect the level of uncertainty.
6. simplified_extanglement_decoding ( . . . ) function: This is a simplified
   illustration of Extanglement-aware decoding.
      It takes a probability distribution, an Extanglement threshold, and a flag to choose between Entropy or Gap metric.
      It calculates the chosen Extanglement metric.
      It compares the Extanglement metric to the threshold.
      If uncertainty is “high” (Extanglement exceeds/falls below threshold, depending on metric), it prints a message and returns a placeholder <UNCERTAIN_TOKEN> (in a real system, this would trigger the uncertainty handling operations).
      If uncertainty is “low enough,” it performs a greedy token selection (argmax) and returns a “predicted token” (for simplicity, tokens are named “Token_1”, “Token_2” etc.).
   Example Decoding Runs: Demonstrates using the simplified_extanglement_decoding function with Entropy and Probability, Gini, Top-K showing how the decoding logic would work in principle.

```
      “1”: “Entropy-based Extanglement”,
      “2”: “Probability Gap Extanglement”,
      “3”: “Gini Impurity Extanglement”,
      “4”: “Top-K Probability Mass Extanglement”
  import numpy as np
  from scipy.stats import entropy
  # --- Extanglement Metric Functions ---
  def entropy_extanglement(prob_distribution):
    “““Calculates Entropy-based Extanglement (Shannon Entropy).”””
    prob_distribution = np.array(prob_distribution)
    prob_distribution = prob_distribution / np.sum(prob_distribution) # Ensure it's a
probability distribution
    ent_value = entropy(prob_distribution, base=2)
    return ent_value
  def probability_gap_extanglement(prob_distribution):
    “““Calculates Probability Gap Extanglement (difference between top 2
probabilities).”””
    prob_distribution = np.array(prob_distribution)
    top_probs_indices = np.argsort(prob_distribution)[::−1]
    top_prob = prob_distribution[top_probs_indices[0]]
    second_top_prob = prob_distribution[top_probs_indices[1]]
    prob_gap = top_prob − second_top_prob
    return prob_gap
  def gini_impurity_extanglement(prob_distribution):
    “““Calculates Gini Impurity Extanglement.”””
    prob_distribution = np.array(prob_distribution)
    gini_value = 1 − np.sum(prob_distribution2)
    return gini_value
  def top_k_probability_mass_extanglement(prob_distribution, k=3):
    Calculates Top-K Probability Mass Extanglement.”””
    prob_distribution = np.array(prob_distribution)
    top_k_indices = np.argsort(prob_distribution)[::−1][:k] # Get indices of top K
probabilities
    top_k_prob_mass = np.sum(prob_distribution[top_k_indices])
    top_k_extanglement = 1 − top_k_prob_mass
    return top_k_extanglement
  def get_valid_distribution_input( ):
    “““Prompts user to enter a probability distribution and validates it.”””
    while True:
      try:
        dist_str = input(“Enter probability distribution (comma-separated numbers, e.g.,
0.8,0.1,0.1):”)
        prob_distribution = [float(p) for p in dist_str.split(‘,’)]
        if any(p < 0 for p in prob_distribution):
          print(“Probabilities cannot be negative. Please enter non-negative numbers.”)
          continue
        if not np.isclose(sum(prob_distribution), 1.0): # Allow for minor floating point
inaccuracies
          print(“Probabilities should ideally sum to 1. Please check your input (it will be
normalized).”)
        return prob_distribution
      except ValueError:
        print(“Invalid input. Please enter comma-separated numbers.”)
  def main( ):
    “““Main function for the Extanglement CLI.”””
    metric_options = {
      “1”: “Entropy-based Extanglement”,
      “2”: “Probability Gap Extanglement”,
      “3”: “Gini Impurity Extanglement”,
      “4”: “Top-K Probability Mass Extanglement”
    }
    metric_functions = {
      “1”: entropy_extanglement,
      “2”: probability_gap_extanglement,
      “3”: gini_impurity_extanglement,
      “4”: top_k_probability_mass_extanglement
    }
    while True:
      print(“\n--- Extanglement Calculator ---”)
      print(“Choose Extanglement Metric:”)
      for key, option in metric_options.items( ):
        print(f“{key}. {option}”)
      metric_choice = input(“Enter your choice (1-4): ”)
      if metric_choice not in metric_options:
        print(“Invalid choice. Please enter 1, 2, 3, or 4.”)
        continue
      chosen_metric_name = metric_options[metric_choice]
      chosen_metric_function = metric_functions[metric_choice]
      prob_distribution = get_valid_distribution_input( )
      normalized_distribution = np.array(prob_distribution) / np.sum(prob_distribution) #
Normalize
      # Calculate Extanglement
      if chosen_metric_name == “Top-K Probability Mass Extanglement”:
        k_value = int(input(“Enter value for K (e.g., 3): ”))
        extanglement_value = chosen_metric_function(normalized_distribution,
k=k_value)
      else:
        extanglement_value = chosen_metric_function(normalized_distribution)
      print(f“\n--- Results ---”)
      print(f“Extanglement Metric: {chosen_metric_name}”)
      print(f“Probability Distribution (Normalized): {normalized_distribution.tolist( )}”)
      print(f“Extanglement Value: {extanglement_value:.4f}”)
      repeat = input(“\nCalculate again? (yes/no): ”).lower( )
      if repeat != ‘yes':
        print(“Exiting Extanglement Calculator.”)
        break
  if _{——}name_{——} == “_{——}main_{——}”:
    main( )
```

1. A method for decoding in an Artificial Intelligence Transformer model for generating a sequence of tokens, comprising:
generating a probability distribution over a vocabulary for a next token prediction from a softmax layer of the Transformer model, said probability distribution representing model uncertainty for the next token prediction;
calculating an Extanglement metric for said probability distribution, wherein the Extanglement metric is a quantitative measure of uncertainty associated with the probability distribution;
comparing the calculated Extanglement metric to a predetermined or dynamically adjusted Extanglement threshold;
responsive to the Extanglement metric exceeding or falling below the Extanglement threshold, indicating a level of uncertainty exceeding a predetermined acceptable level, performing at least one uncertainty handling operation selected from the group consisting of: pausing token commitment, performing further internal processing within the Transformer model, dynamically adjusting decoding parameters of the Transformer model, iterative refinement of the token prediction, re-sampling from the probability distribution, and combinations thereof;
responsive to the Extanglement metric being below or above the Extanglement threshold, indicating a level of uncertainty within a predetermined acceptable level, selecting a token from the probability distribution according to a token selection strategy and outputting said selected token as the next token in the generated sequence; and
iteratively repeating for subsequent token predictions to generate a sequence of tokens until a termination condition is met.

2. The method of claim 1, wherein the Extanglement metric is selected from the group consisting of: entropy of the probability distribution, probability gap between the most likely token and the second most likely token in the probability distribution, Gini Impurity of the probability distribution, and Top-K Probability Mass of the probability distribution.

3. The method of claim 1, wherein the uncertainty handling operation comprises introducing a pause mechanism to delay token commitment, allowing for further internal processing within the Transformer model before token selection.

4. The method of claim 1, wherein the uncertainty handling operation comprises performing further internal processing within the Transformer model, wherein said further internal processing is selected from the group consisting of iterative refinement of hidden states and re-sampling from intermediate representations.

5. The method of claim 4, wherein the iterative refinement comprises re-running one or more decoder layers of the Transformer model to refine the probability distribution before token selection.

6. The method of claim 1, wherein the uncertainty handling operation comprises dynamically adjusting decoding parameters, and wherein the decoding parameters being dynamically adjusted are selected from the group consisting of: decoding temperature, token sampling strategy, and parameters of the token sampling strategy.

7. The method of claim 1, wherein selecting a token comprises selecting the token with the highest probability from the probability distribution when the Extanglement metric is below or above the Extanglement threshold, indicating acceptable uncertainty.

8. The method of claim 1, wherein selecting a token comprises sampling from the top tokens of the probability distribution, using a sampling strategy, when the Extanglement metric is below or above the Extanglement threshold, indicating acceptable uncertainty.

9. The method of claim 1, comprising running an Artificial Intelligence system for text generation, comprising a Transformer model and an Extanglement Decoder module.

10. The method of claim 11, wherein the extanglement metric is entropy of the probability distribution.

11. A method, comprising:
generating a probability distribution over a vocabulary for a next token prediction from a softmax layer of a transformer model;
calculating an extanglement metric for said probability distribution, wherein extanglement is a measure of uncertainty associated with the probability distribution;
comparing the extanglement metric to an extanglement threshold;
if the extanglement metric exceeds the extanglement threshold, performing an uncertainty handling operation selected from the group consisting of: pausing token commitment, performing further internal processing, dynamically adjusting decoding parameters, and combinations thereof;
if the extanglement metric is below the extanglement threshold, selecting a token from the probability distribution and outputting said token;
repeating for subsequent token predictions to generate a sequence of tokens.

12. The method of claim 11, wherein the extanglement metric is selected from the group consisting of: entropy of the probability distribution, probability gap between the most likely token and the second most likely token, and other information-theoretic measures reflecting distribution spread or peakedness.

13. The method of claim 11, wherein the uncertainty handling operation comprises introducing a pause mechanism to delay token commitment or dynamically adjusting decoding parameters including temperature or sampling strategy.

14. The method of claim 11, wherein (original) The method reduces hallucinations in the generated token sequence compared to methods that force certainty through low temperature or greedy decoding.

15. The method of claim 11, wherein the extanglement comprises a distribution providing a confidence signal for a transformer to make a binary decision even if the decision is wrong and wherein extanglement is a multidimensional factor.

16. The method of claim 11, wherein selecting a token comprises sampling from the top tokens of the probability distribution when the extanglement metric is below the extanglement threshold.

17. The method of claim 11, wherein the uncertainty handling operation comprises dynamically adjusting decoding parameters.

18. A method for uncertainty-aware decoding in an artificial intelligence transformer model, comprising:
generating a probability distribution over a vocabulary for a next token prediction;
calculating an extanglement metric for the probability distribution;
comparing the extanglement metric to an extanglement threshold;
performing an uncertainty handling operation if the extanglement metric exceeds the threshold;
selecting and outputting a token if the extanglement metric is below the threshold;
repeating the steps for subsequent token predictions.

19. The method of claim 18, further comprising generating the probability distribution using a decoding temperature greater than zero.

20. The method of claim 18, wherein the extanglement threshold is determined empirically, is adaptively adjusted based on task requirements, or is adaptively adjusted based on model performance.
